(19) United States
(12) Patent Application Publication
(10) Pub. No.: US 2025/0219866 A1
(43) Pub. Date: Jul. 3, 2025

(54) COMMUNICATION TRANSCEIVER

(71) Applicant: DENSO CORPORATION, Kariya-city (JP)

(72) Inventor: TAICHI ITAGAWA, Kariya-city (JP)

(21) Appl. No.: 18/909,468

(22) Filed: Oct. 8, 2024

(30) Foreign Application Priority Data
Dec. 28, 2023 (JP) 2023-223202

(51) Int. Cl. H04L 12/40

(52) U.S. Cl. CPC H04L 12/40032; H04L 12/40071; H04L 2012/40273

(57) ABSTRACT

A communication transceiver is connected to a main control unit of a communication device. The communication transceiver includes a service control unit and a service interface unit. The service control unit transmits a service presentation message to the electronic control device conforming to a first protocol of service-oriented communication based on first setting information set in response to an instruction from the main control unit. When service-oriented communication is established, the service interface unit converts the communication data conforming to a second protocol received from the main control unit into the communication data conforming to the first protocol based on second setting information set in response to an instruction from the main control unit, and transmits a converted communication data to the electronic control device.

### CROSS REFERENCE TO RELATED APPLICATION

The present application claims the benefit of priority from Japanese Patent Application No. 2023-223202 filed on Dec. 28, 2023. The entire disclosure of the above application is incorporated herein by reference.

### TECHNICAL FIELD

The present disclosure relates to a technique for achieving service-oriented communication.

### BACKGROUND ART

The in-vehicle communication system according to a conceivable technique includes an integrated ECU, a plurality of relay ECUs connected to the integrated ECU, and a plurality of ECUs connected to each of the plurality of relay ECUs, and performs service-oriented communication with the integrated ECU as a server and the plurality of relay ECUs and the plurality of ECUs as clients. Specifically, in the above-described in-vehicle communication system, each of the relay ECUS as relay devices converts data conforming to a protocol other than the service-oriented protocol into the service-oriented protocol, thereby the service-oriented communication is realized between each of the relay devices and the integrated ECU.

### SUMMARY OF INVENTION

According to an example, a communication transceiver is connected to a main control unit of a communication device. The communication transceiver may include a service control unit and a service interface unit. The service control unit transmits a service presentation message to the electronic control device conforming to a first protocol of service-oriented communication based on first setting information set in response to an instruction from the main control unit. When service-oriented communication is established, the service interface unit converts the communication data conforming to a second protocol received from the main control unit into the communication data conforming to the first protocol based on second setting information set in response to an instruction from the main control unit, and transmits a converted communication data to the electronic control device.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating the configuration of a communication system according to an embodiment;

FIG. 2 is a block diagram showing a configuration of a first server ECU and a first client ECU according to the embodiment;

FIG. 3 is a block diagram showing a configuration of a second server ECU and a second client ECU according to the embodiment;

FIG. 4 is a diagram showing a data flow within the first server ECU and the second server ECU according to the embodiment;

FIG. 5 is a diagram showing an example of the presentation of service provided by the host devices of the first server ECU and the second server ECU according to the embodiment and set values related to the subject node;

FIG. 6 is a diagram illustrating an example of the set value to be used for data mutual conversion between the host devices of the first and second server ECUs and a client ECU according to the embodiment;

FIG. 7 is a diagram showing an example of information regarding the client ECU that subscribes to a distribution event provided by host devices of the first and second server ECUs according to the embodiment;

FIG. 8 is a sequence diagram showing a first example of a first pattern of the service-oriented communication according to the embodiment;

FIG. 9 is a sequence diagram showing a second example of a first pattern of the service-oriented communication according to the embodiment;

FIG. 10 is a sequence diagram showing a second pattern of the service-oriented communication according to the embodiment;

FIGS. 11A and 11B are diagrams showing the transition of the service provision state of the service transceivers of the first and second server ECUs according to the embodiment; and

FIGS. 12A and 12B are diagrams showing the transition of an event distribution state of the service transceivers of the first and second server ECUs according to the embodiment.

### DETAILED DESCRIPTION

In the in-vehicle communication system according to the conceivable technique, the processing unit of the integrated ECU includes a protocol stack for the service-oriented communication and generates a message of the service-oriented protocol. However, depending on the application of the ECU, the microcomputer included in the ECU may have low processing capability or may only output RAW data. It is not possible to implement a protocol stack in such a microcontroller.

One aspect of the present embodiments provides a technique for achieving service-oriented communication even in a case where a protocol stack cannot be implemented in a main control unit of a communication device.

A communication transceiver according to one aspect of the present embodiments is connected to a main control unit of a communication device configured to be connected to an electronic control device via a single or multiple communication lines. The communication transceiver includes a service control unit and a service interface unit. The service control unit transmits a presentation message offering to provide a service to the electronic control device in accordance with the first protocol, which is a service-oriented communication protocol, based on first setting information set in response to an instruction from the main control unit. When the service-oriented communication is established by the presentation message, the service interface unit, based on second setting information set in response to an instruction from the main control unit, (i) converts communication data according to the second protocol received from the main control unit into communication data according to the first protocol and transmits it to the electronic control device, or (ii) converts the communication data according to the first protocol received from the electronic control device into the communication data according to the second protocol and transmits it to the main control unit.

A communication transceiver according to one aspect of the present embodiments is connected to a main control unit, and first setting information and second setting information are set. Thus, it is possible to introduce the service-oriented communication into the communication device even if a protocol stack for service communication cannot be implemented in the main control unit. Thus, the service-oriented communication can be realized overall between the communication device and the electronic control device.

### 1. Configuration

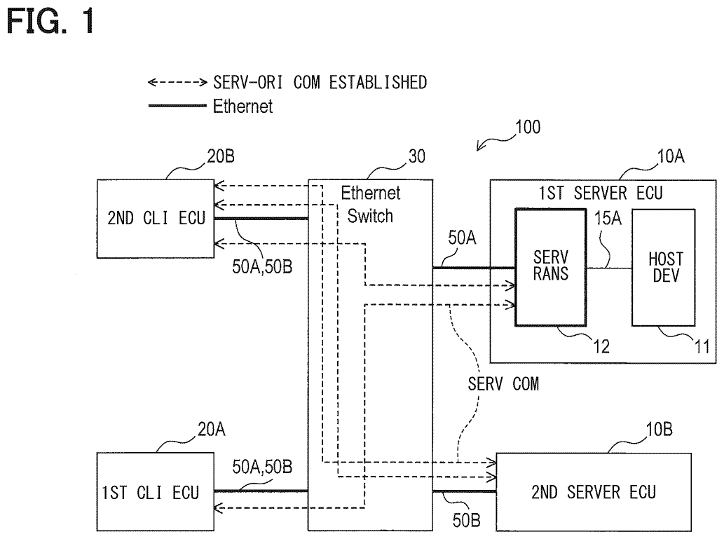

The following will describe a configuration of a communication system 100 according to the present embodiment with reference to FIG. 1. In this embodiment, the communication system 100 is mounted on a vehicle. In another embodiment, at least a part of the communication system 100 may be installed in a moving body other than a vehicle, such as a ship, a train, or an airplane, or in a building, or may be in a mobile terminal.

The communication system 100 includes a first server electronic control device (hereinafter, referred to as ECU) 10A, a second server ECU 10B, a first client ECU 20A, a second client ECU 20B, and an Ethernet switch 30. In this embodiment, the first server ECU 10A and the second server ECU 10B correspond to the communication device of the present disclosure, and the first client ECU 20A and the second client ECU 20B correspond to the electronic control device of the present disclosure.

In another embodiment, the communication system 100 may have one or more first server ECUs 10A and not have a second server ECU 10B, or may have one or more second server ECUs 10B and not have a first server ECU 10A. Alternatively, the communication system 100 may include another server ECU in addition to the first server ECU 10A and/or the second server ECU 10B.

In another embodiment, the communication system 100 may have one or more first client ECs 20A and no second client ECU 20B, or may have one or more second client ECUs 20B and no first client ECU 20A. Alternatively, the communication system 100 may include another client ECU in addition to the first client ECU 20A and/or the second client ECU 20B.

The basic configuration of the first server ECU 10A is the same as the basic configuration of the second server ECU 10B. The first server ECU 10A is connected to the Ethernet switch 30 via a first Ethernet signal line 50A. The second server ECU 10B is connected to the Ethernet switch 30 via a second Ethernet signal line 50B. The first Ethernet signal line 50A and the second Ethernet signal line 50B transmit signals according to the Ethernet protocol. “Ethernet” is a registered trademark. In another embodiment, the first server ECU 10A may be connected to the Ethernet switch 30 via another Ethernet signal line in addition to the first Ethernet signal line 50A. Furthermore, the second server ECU 10B may be connected to the Ethernet switch 30 via another Ethernet signal line in addition to the second Ethernet signal line 50B.

The basic configuration of the first client ECU 20A is the same as the basic configuration of the second client ECU 20B. Each of the first client ECU 20A and the second client ECU 20B is connected to the Ethernet switch 30 via a first Ethernet signal line 50A and/or a second Ethernet signal line 50B. In this embodiment, the bandwidth of the first Ethernet signal line 50A is wider than the bandwidth of the second Ethernet signal line 50B. For example, the bandwidth of the first Ethernet signal line 50A is 10 Gbits per second, and the bandwidth of the second Ethernet signal line 50B is 10 Mbits per second. In another embodiment, each of the first client ECU 20A and the second client ECU 20B may be connected to the Ethernet switch 30 via other Ethernet signal lines in addition to the first Ethernet signal line 50A and/or the second Ethernet signal line 50B.

The Ethernet switch 30 establishes Ethernet communication between the first server ECU 10A and the first client ECU 20A and/or the second client ECU 20B, and between the second server ECU 10B and the first client ECU 20A and/or the second client ECU 20B. In addition, the Ethernet switch 30 may establish Ethernet communication between the first server ECU 10A and the second server ECU 10B, or may establish Ethernet communication between the first client ECU 20A and the second client ECU 20B. The Ethernet switch 30 relays Ethernet packets between ECUs with which Ethernet communication has been established.

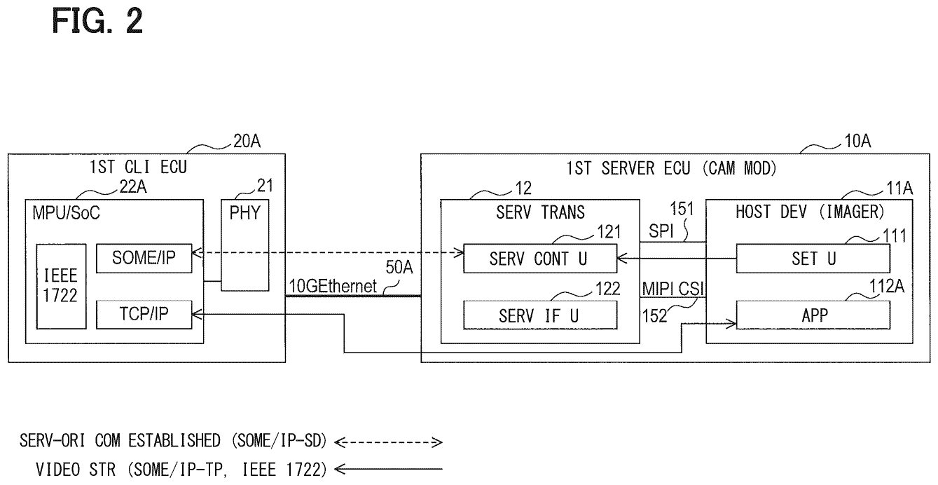

As shown in FIG. 2, the first server ECU 10A is a camera module that captures video and transmits a video stream to the first client ECU 20A and/or the second client ECU 20B. A video stream is stream data that is generated continuously and may include time information.

The first server ECU 10A includes a host device 11A, a service transceiver 12, and a signal line 151 and a signal line 152 as a first server signal line 15A.

The host device 11A is an imager, and includes a setting unit 111 and an application 112A. The host device 11A executes the application 112A to provide a camera service to the first client ECU 20A and/or the second client ECU 20B. The host device 11A does not have a protocol stack because the host device 11A only outputs a video stream, which is RAW data, via an interface.

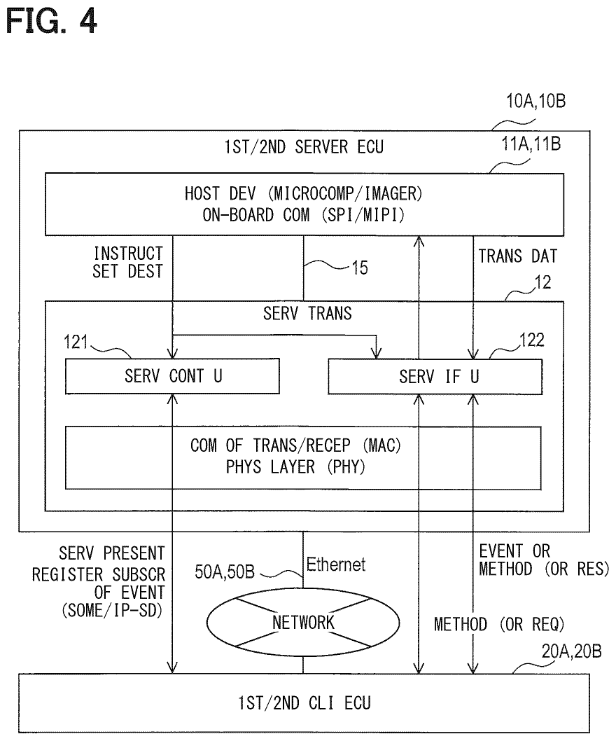

As shown in FIG. 4, the setting unit 111 has first setting information to be used for communication with the first and second client ECUs 20A, 20B, and instructs the service control unit 121 (described later) to write the first setting information via a signal line 151 (described later). The setting unit 111 also has second setting information to be used for communication with the first and second client ECUs 20A, 20B, and instructs a service IF unit 122 (described later) via a signal line 151 to write the second setting information. The first and second setting information are set when the first server ECU 10A is designed.

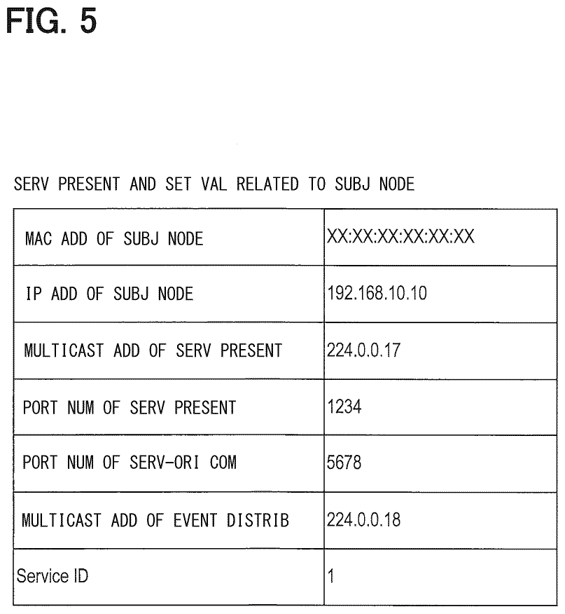

Specifically, as shown in FIG. 5, the first setting information provides a setting value related to the presentation of a service and the subject node, and includes the MAC address of the subject node, the IP address of the subject node, a multicast address for service presentation, a port number for service presentation, a port number for service-oriented communication, a multicast address for event distribution, and a service ID. The port number is the numerical number that identifies the application for passing the packet. The service ID is the numerical number that identifies a service provided by the first server ECU 10A.

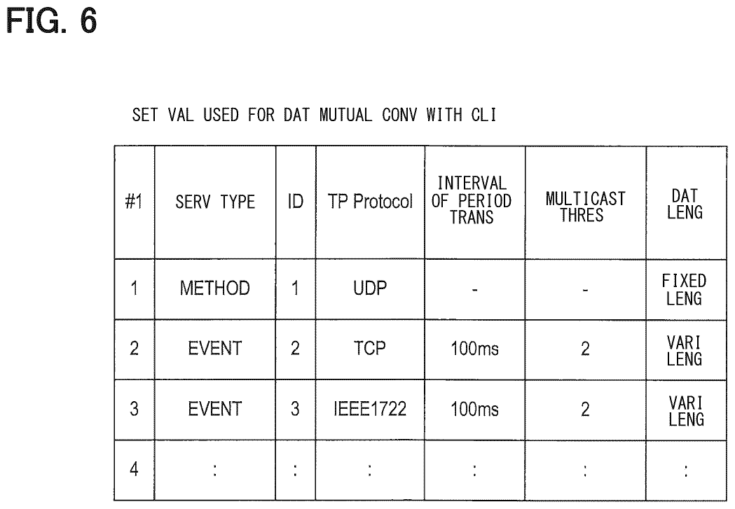

As shown in FIG. 6, the second setting information provides a setting value to be used for data conversion with the client ECU. The second setting information is, for example, a table, and is information that associates a service type, an event ID, a transport layer protocol type, a periodic transmission interval, a multicast threshold, and a data length. The service type includes a method and an event. The type of the transport layer protocol includes TCP/IP, UDP, and IEEE1722.

The function of the setting unit 111 may be realized by software or hardware. Alternatively, the function of the setting unit 111 may be realized by a combination of software and hardware.

The host device 11A performs on-board communication with the service transceiver 12 via the first server signal line 15A, which involves a relatively small processing load. The first server signal line 15A includes a signal line 151 and a signal line 152.

The signal line 151 is a signal line for transmitting and receiving small amounts of data such as setting values and notifications between the host device 11A and the service transceiver 12. The signal line 151 conforms to a Serial Peripheral Interface (hereinafter, referred to as SPI) or the like. The signal line 152 is a signal line for transmitting large volume data such as a video stream. The signal line 152 conforms to Mobile Industry Processor Interface—Camera Serial Interface (hereinafter, MIPI-CSI), Mobile Industry Processor Interface—Camera Serial Interface 2 (hereinafter, MIPI-CSI2), Mobile Industry Processor Interface—Display Serial Interface (hereinafter, MIPI-DSI), and the like. In this embodiment, SPI, MIPI-CSI, MIPI-CSI2, and MIPI-DSI correspond to the second protocol of the present disclosure.

The service transceiver 12 implements a protocol stack for realizing the service-oriented communication. Specifically, the service transceiver 12 implements the service-oriented communication protocol such as Scalable service-Oriented Middleware over Internet Protocol (hereinafter, SOME/IP) and Data Distribution Service (hereinafter, DDS). SOME/IP and DDS are realized on the Transmission Control Protocol/Internet Protocol (hereinafter referred to as TCP/IP).

That is, since the first server ECU 10A cannot implement a protocol stack for realizing the service-oriented communication in the host device 11A, the protocol stack for realizing the service-oriented communication is implemented in the service transceiver 12. This enables the first server ECU 10A to perform the service-oriented communication with the first and second client ECUs 20A, 20B.

Furthermore, the service transceiver 12 implements a protocol stack for distributing large amounts of data. Specifically, the service transceiver 12 implements a protocol such as the Institute of Electrical and Electronics Engineers (hereinafter referred to as IEEE) 1722 in order to distribute large amounts of data. In this embodiment, SOME/IP and DDS correspond to the first protocol of the present disclosure, and IEEE1722 corresponds to the third protocol of the present disclosure.

The service transceiver 12 includes a service control unit 121 and a service interface (hereinafter, referred to as IF) unit 122.

As shown in FIG. 4, the service control unit 121 transmits a presentation message for presenting a service conforming to the first protocol to the first and second client ECUs 20A and 20B via the first Ethernet signal line 50A. The presentation message includes a service ID and indicates the content of the service provided by the first server ECU 10A.

The service control unit 121 receives a request for subscription to event communication according to the first protocol via the first Ethernet signal line 50A from the first client ECU 20A and/or the second client ECU 20B that received the presentation message. Then, based on the received subscription request, the service control unit 121 registers, in the service IF unit 122, information on the client ECU that is the request source of the subscription.

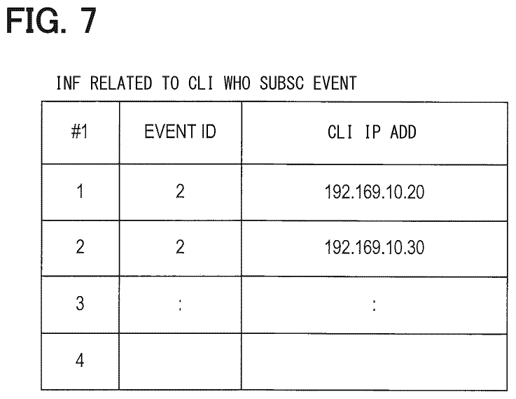

The service IF unit 122 has client information related to a client ECU that subscribes to an event. Specifically, as shown in FIG. 7, the client information is, for example, a table in which the ID of an event distributed by the first server ECU 10A is in connection with the IP address of a client ECU that subscribes to the event.

The service IF unit 122 receives the communication data conforming to the second protocol from the host device 11A via the signal line 152, and converts the communication data conforming to the second protocol into communication data conforming to the first or third protocol.

Then, the service IF unit 122 refers to the registration information and transmits the communication data conforming to the first or third protocol via the first Ethernet signal line 50A to the client ECU that is the request source of the subscription. This communication data is a video stream.

The functions of the service control unit 121 and the service IF unit 122 may be realized by software or by hardware. Alternatively, the functions of the service control unit 121 and the service IF unit 122 may be realized by a combination of software and hardware.

As shown in FIG. 2, the first client ECU 20A includes a physical layer 21 and an MPU 22A. The MPU 22A is a micro-processing unit, or system on chip, and implements the protocols of the SOME/IP, TCP/IP, and IEEE 1722.

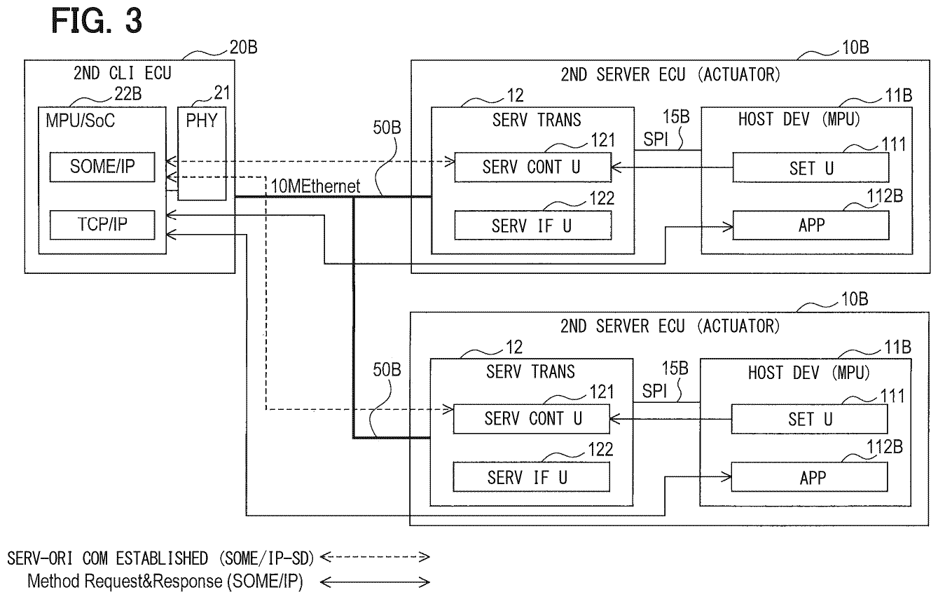

As shown in FIG. 3, the second server ECU 10B is a control device that controls an actuator, and controls the actuator upon receiving a request from the first client ECU 20A and/or the second client ECU 20B.

The second server ECU 10B includes a host device 11B, a service transceiver 12, and a second server signal line 15B.

The host device 11B is a micro-processing unit (hereinafter, MPU), and includes a setting unit 111 and an application 112B. The host device 11B executes the application 112B to provide an actuator-related service to the first client ECU 20A and/or the second client ECU 20B. The function of the setting unit 111 of the host device 11B is similar to the function of the setting unit 111 of the host device 11A.

The host device 11B performs on-board communication with the service transceiver 12 via the second server signal line 15B, which involves a relatively small processing load. The second server signal line 15B supports SPI and the like.

The service transceiver 12 includes a service control unit 121 and a service IF unit 122. The function of the service transceiver 12 of the second server ECU 10B is similar to the function of the service transceiver 12 of the first server ECU 10A.

The host device 11B is a small-scale microcomputer for controlling the actuator. Since the protocol stack for realizing the service-oriented communication requires a large processing load, and therefore it is difficult to implement the protocol stack in the host device 11B. Therefore, similar to the first server ECU 10A, the service transceiver 12 of the second server ECU 10B implements a protocol stack for realizing the service-oriented communication.

The service IF unit 122 converts the communication data conforming to the first protocol received from the first client ECU 20A and/or the second client ECU 20B via the second Ethernet signal line 50B into the communication data conforming to the second protocol. Then, the service IF unit 122 transmits the communication data conforming to the second protocol to the host device 11B via the second server signal line 15B. The communication data conforming to the first protocol is, for example, a request message.

Furthermore, the service IF unit 122 receives the communication data conforming to the second protocol from the host device 11B via the second server signal line 15B, and converts the communication data conforming to the second protocol into the communication data conforming to the first protocol. Then, the service IF unit 122 transmits the communication data conforming to the first protocol to the client ECU conforming to the second communication data via the second Ethernet signal line 50B. The communication data conforming to the second protocol is, for example, a response message.

In this embodiment, the host devices 11A and 11B correspond to a main control unit in the present disclosure, and the service transceiver 12 corresponds to a communication transceiver in the present disclosure.

As shown in FIG. 3, the second client ECU 20B includes a physical layer 21 and an MPU 22B. The MPU 22B is a micro-processing unit or system on chip, and implements the SOME/IP and TCP/IP protocols.

### 2. Process

### 2-1. First Example of Service-Oriented Communication in the First Pattern)

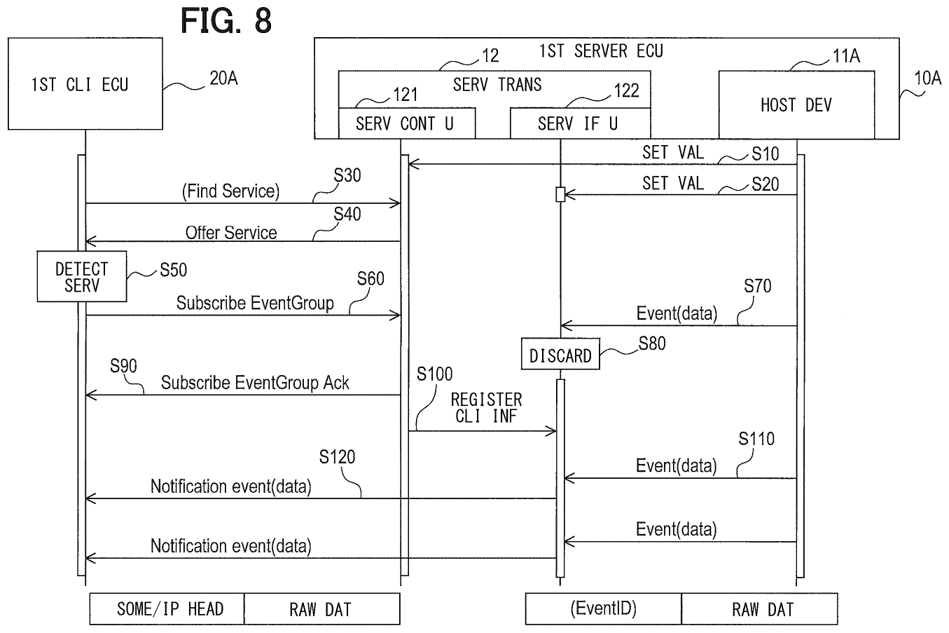

Next, a process flow in a first example of the first pattern of the service-oriented communication will be described with reference to the sequence diagram of FIG. 8. The first pattern is one of various patterns of the service-oriented communication, and in the first pattern, the first server ECU 10A periodically distributes an event to the first client ECU 20A. Here, the process in which the first server ECU 10A distributes events to the first client ECU 20A is described. Alternatively, the first server ECU 10A may distribute events to the second client ECU 20B or other client ECUs in addition to or instead of the first client ECU 20A.

In S10, the host device 11A transmits the first setting information conforming to the SPI to the service control unit 121 via the signal line 151, and instructs the service control unit 121 to write the first setting information.

In S20, the host device 11A transmits the second setting information conforming to the SPI to the service IF unit 122 via the signal line 151, and instructs the service IF unit 122 to write the second setting information.

In S30, the first client ECU 20A transmits a search message (i.e., Find Service) conforming to SOME/IP to the service control unit 121 via the first Ethernet signal line 50A. The search message is a message for searching for available services. In another embodiment, the process of S30 may be omitted.

In S40, upon receiving the search message or upon activating the first server ECU 10A, the service control unit 121 transmits a presentation message (i.e., Offer Service) conforming to the SOME/IP to the first client ECU 20A via the first Ethernet signal line 50A based on the first setting information. The presentation message indicates that the first server ECU 10A provides a service of periodically distributing a video stream.

Next, in S50, the first client ECU 20A receives the presentation message and detects the services that can be provided. That is, the first client ECU 20A detects a subscribeable event communication. When the first client ECU 20A detects the service, the service-oriented communication is established between the first server ECU 10A and the first client ECU 20A.

Next, in S60, the first client ECU 20A requests the service control unit 121 to subscribe to event communication conforming to the SOME/IP. Specifically, the first client ECU 20A transmits a subscription request message (i.e., Subscribe Event Group) conforming to the SOME/IP to the service control unit 121 via the first Ethernet signal line 50A. The subscription request message is a message requesting joining a group that subscribes to the event communication.

Next, in S70, the host device 11A transmits the first event data to the service IF unit 122 via the signal line 152. The first event data conforms to the MIPI-CS1 and includes RAW data of the video stream and an event ID. When the host device 11A transmits only one type of first event data, the first event data may not include an event ID.

Next, in S80, the service IF unit 122 discards the first event data received from the host device 11A because at this point in time, no client that subscribes to the event is registered in the client information.

Next, in S90, the service control unit 121 transmits a subscription acceptance message (i.e., Subscribe Event Group Ack) conforming to the SOME/IP to the first client ECU 20A via the first Ethernet signal line 50A.

Next, in S100, the service control unit 121 registers the first client ECU 20A in the client information in the service IF unit 122. That is, the service control unit 121 registers the IP address of the first client ECU 20A in the client information in association with the event ID of the event communication to be distributed to the first client ECU 20A. If the host device 11A transmits only one type of event data, the service control unit 121 needs to register only the IP address of the first client ECU 20A in the client information. When the first client ECU 20A is registered in the client information, the event communication to the first client ECU 20A starts.

Next, in S110, the host device 11A transmits the first event data to the service IF unit 122 via the signal line 152. The host device 11A repeatedly transmits the first event data to the service IF unit 122 at a predetermined cycle.

Next, in S120, the service IF unit 122 converts the first event data received from the host device 11A into the second event data based on the second setting information. Specifically, the service IF unit 122 deletes the event ID from the first event data and adds a SOME/IP header based on the second setting information to generate the second event data. That is, the second event data conforms to the SOME/IP and includes the RAW data and a SOME/IP header.

The service IF unit 122 transmits the second event data (i.e., Notification event) to the first client ECU 20A via the first Ethernet signal line 50A. Each time the service IF unit 122 receives the first event data from the host device 11A, the service IF unit 122 converts the first event data into second event data and transmits the second event data to the first client ECU 20A.

### 2-2. Second Example of Service-Oriented Communication in the First Pattern)

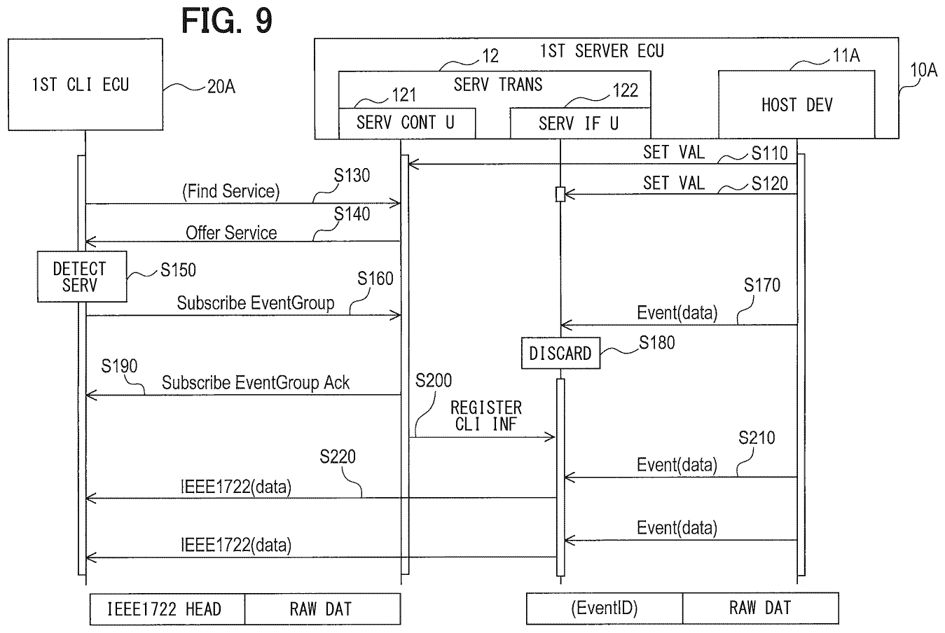

Next, a process flow in a second example of the first pattern of the service-oriented communication will be described with reference to the sequence diagram of FIG. 9.

In steps S110 to S210, the host device 11A, the service control unit 121, the service IF unit 122, and the first client ECU 20A execute the same processes as those in steps S10 to S110.

Next, in S220, the service IF unit 122 converts the first event data received from the host device 11A into the third event data based on the second setting information. Specifically, the service IF unit 122 deletes the event ID from the first event data and adds a IEEE 1772 header based on the second setting information to generate the third event data. That is, the third event data conforms to the IEEE 1772 and includes the RAW data and an IEEE 1772 header.

The service IF unit 122 transmits the third event data to the first client ECU 20A via the first Ethernet signal line 50A. Each time the service IF unit 122 receives the first event data from the host device 11A, the service IF unit 122 converts the first event data into the third event data and transmits the third event data to the first client ECU 20A.

### 2-3. Service-Oriented Communication Between Second Server ECU and Second Client ECU

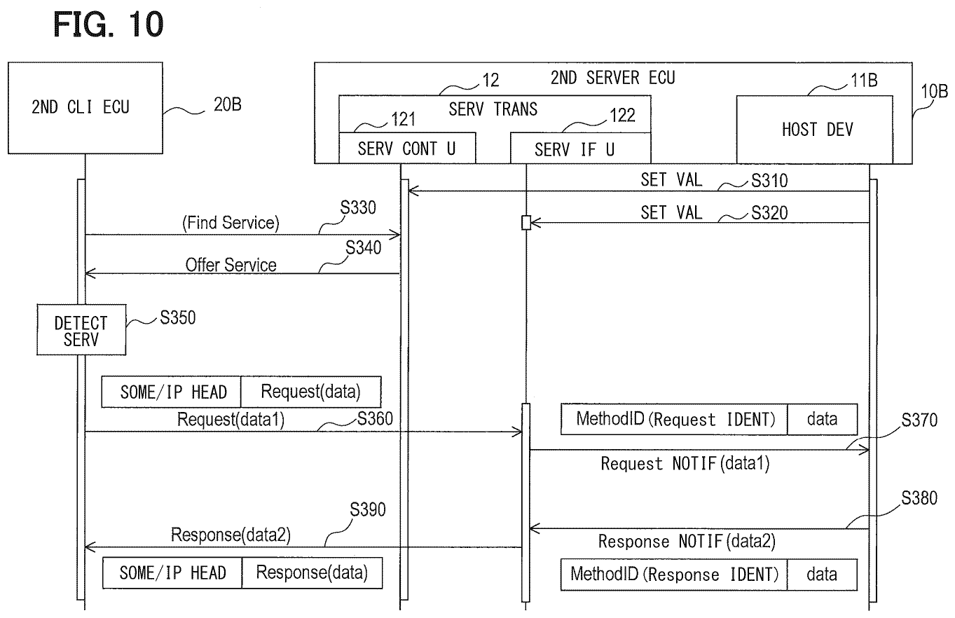

Next, the process flow in the second pattern of the service-oriented communication will be described with reference to the sequence diagram of FIG. 10. In the second pattern, the second client ECU 20B and the second server ECU 10B perform bidirectional communication, and the second server ECU 10B responds every time the second client ECU 20B makes a request. Although the bidirectional communication process between the second server ECU 10B and the second client ECU 20B will be described here, the second server ECU 10B may perform the bidirectional communication with the first client ECU 20A or other client ECUs.

In steps S310 to S350, the host device 11B, the service control unit 121, and the second client ECU 20B execute the same processes as those in steps S10 to S50.

In S360, the second client ECU 20B transmits a first request message to the service IF unit 122 via the second Ethernet signal line 50B. The first request message conforms to the SOME/IP and includes a SOME/IP header and the first data.

In S370, the service IF unit 122 converts the received first request message into a second request message based on the second setting information. Specifically, the service IF unit 122 deletes the SOME/IP header from the first request message, and adds a Method ID to generate a second request message. That is, the second request message conforms to the SPI and includes a method ID and first data.

The service IF unit 122 selects a request identifier based on the second setting information, and transmits a second request message together with the request identifier to the host device 11B via the second server signal line 15B. At this time, the service IF unit 22 may add an identifier indicating that the second request message is a request message.

In S380, the host device 11B transmits the first response message together with the response identifier to the service IF unit 122 via the second server signal line 15B. The first response message is a response to the second request message, conforms to the SPI, and includes a method ID and the second data. At this time, the host device 11B may add an identifier to the first response message indicating that the first response message is a response message.

In S390, the service IF unit 122 converts the received first response message into a second response message based on the second setting information. Specifically, the service IF unit 122 deletes the method ID from the second response message and adds a SOME/IP header to generate the second response message. That is, the second response message conforms to the SOME/IP and includes a SOME/IP header and the second data. The service IF unit 122 transmits the second response message to the second client ECU 20B via the second Ethernet signal line 50B.

### 3. State Transition

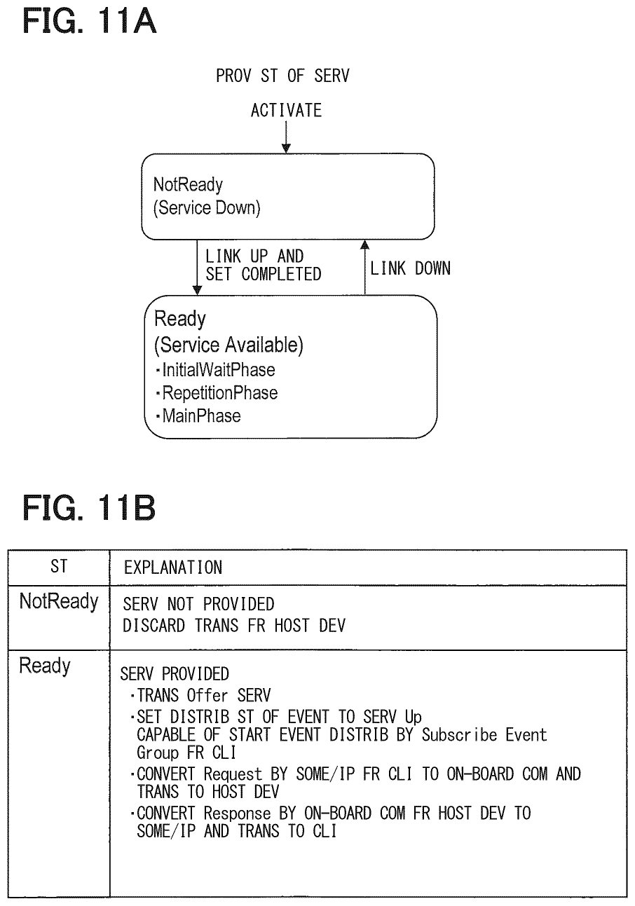

Next, the transition of the service provision state of the first server ECU 10A will be described with reference to FIGS. 11A and 11B. The transition of the service provision state of the second server ECU 10B is similar to the transition of the service provision state of the first server ECU 10A, and therefore a description thereof will be omitted. After the first server ECU 10A is activated, the service provision state transitions between a Not-Ready state and a Ready state.

In the Not-Ready state, no service is provided by the first server ECU 10A. In this state, the service IF unit 122 discards the data transmitted from the host device 11A.

In the Ready state, a service is provided from the first server ECU 10A. In this state, the service control unit 121 transmits an Offer Service. The service IF unit 122 receives a Subscribe Event Group from the client ECU and starts the event communication.

In the Ready state, the service IF unit 122 converts a request message from the client ECU via the SOME/IP into a request message conforming to the on-board communication, and transmits the request message to the host device 11A. Furthermore, the service IF unit 122 converts a response message received from the host device 11A via the on-board communication into a response message conforming to the SOME/IP, and transmits the response message to the client ECU.

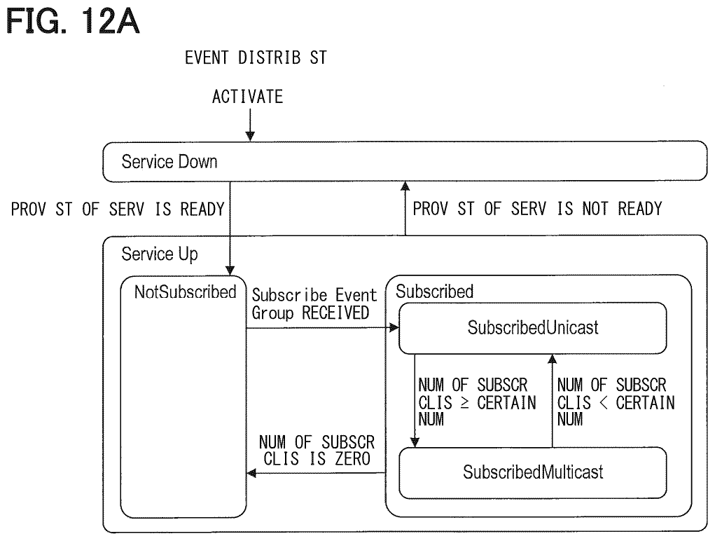

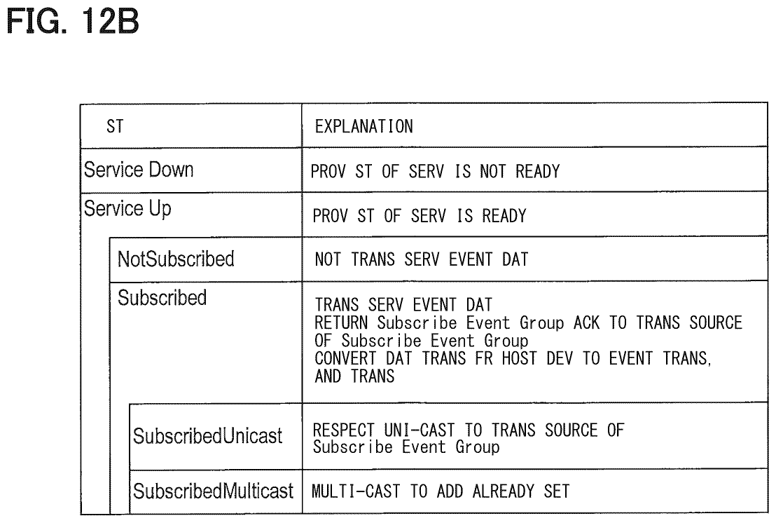

Next, the transition of the event distribution state of the first server ECU 10A will be described with reference to FIGS. 12A and 12B. The transition of the event distribution state of the second server ECU 10B is similar to the transition of the event distribution state of the first server ECU 10A, and therefore a description thereof will be omitted. After the first server ECU 10A is activated, the event distribution state transitions between a Service-Down state and a Service-Up state.

In the Service-Down state, the service provision state is a Not-Ready state. In the Service-Down state, when the service provision state transitions from the Not-Ready state to the Ready state, the event distribution state transitions from the Service-Down state to the Service-Up state.

In the Service-Up state, the service provision state is the Ready state. In the Service-Up state, the service distribution state transitions between the Not-Subscribed state and the Subscribed state. The initial state is the Not-Subscribed state. In the Not-Subscribed state, the first server ECU 10A does not transmit events.

In the Subscribed state, the first server ECU 10A performs the event distribution. In the Subscribed state, the service distribution state transitions between a Subscribed-Multicast state and a Subscribed-Unicast state. In the Subscribed-Multicast state, a certain number of client ECUs subscribe to the event. In the Subscribed-Unicast state, less than a certain number of client ECUs subscribe to the event.

When a Subscribed Event Group is received from a client ECU in the Service-Up state, the event distribution state transitions from the Not-Subscribed state to the Subscribed-Unicast state. In the Subscribed-Unicast state, when the number of clients subscribing to the event reaches or exceeds a certain number, the event distribution state transitions from the Subscribed-Unicast state to the Subscribed- Multicast state. In the Subscribed-Multicast state, when the number of clients subscribing to the event falls below a certain number, the event distribution state transitions from the Subscribed-Multicast state to the Subscribed-Unicast state.

When the number of clients subscribing to the event becomes zero in the Subscribed state, the event distribution state transitions from the Subscribed state to the Not-Subscribed state. Furthermore, when the service provision state transitions from the Ready state to the Not-Ready state in the Subscribed state, the event distribution state transitions from the Service-Up state to the Service-Down state.

### 4. Effect

According to the present embodiment described in detail above, the following effects are obtained.

(1) The first and second server ECUs 10A, 10B are equipped with a service transceiver 12 having a service control unit 121 and a service IF unit 122, and the first setting information is set in the service control unit 121 and the second setting information is set in the service IF unit 122. This makes it possible to introduce the service-oriented communication to the first and second server ECUs 10A and 10B even if the host devices 11A and 11B cannot implement a protocol stack for the service-oriented communication.

(2) The service control unit 121 transmits a presentation message to the first and second client ECUs 20A and 20B based on the first setting information. Then, the service control unit 121 registers the first and second client ECUs 20A and 20B in the service IF unit 122 based on subscription requests from the first and second client ECUs 20A and 20B. Thus, it is possible to distribute the events from the first and second server ECUs 10A and 10B to the first and second client ECUs 20A and 20B even if the host devices 11A and 11B cannot implement a protocol stack for the service-oriented communication.

(3) When large volumes of data are distributed from service IF unit 122, the service IF unit 122 uses the protocol different from the protocol used for communication to establish the service-oriented communication, so that the communication can be made more efficient.

(4) The service IF unit 122 converts the request message and the response message based on the second setting information. Thus, it is possible to transmit the response message from the first and second server ECUs 10A and 10B to the first and second client ECUs 20A and 20B even if the host devices 11A and 11B cannot implement a protocol stack for the service-oriented communication.

### Other Embodiments

Although the embodiments of the present disclosure have been described above, the present disclosure is not limited to the embodiments described above, and various modifications can be made to implement the present disclosure.

(a) In the above embodiment, the first server ECU 10A distributes events in the service-oriented communication. Alternatively, similar to the second server ECU 10B, the first server ECU 10A may also perform bidirectional communication with a client ECU.

(b) In the above embodiment, the second server ECU 10B performs bidirectional communication with the second client ECU 20B in the service-oriented communication. Alternatively, similar to the first server ECU 10A, the second server ECU 10B may also perform event distribution.

(c) The service transceiver 12 and techniques thereof described in the present disclosure may be implemented by a dedicated computer provided by configuring a processor and a memory programmed to execute one or more functions embodied by a computer program. Alternatively, the service transceiver 12 and the technique according to the present disclosure may be achieved by a dedicated computer provided by constituting a processor with one or more dedicated hardware logic circuits. Alternatively, the service transceiver 12 and method described in the present disclosure may be realized by one or more dedicated computer, which is configured as a combination of a processor and a memory, which are programmed to perform one or more functions, and a processor which is configured with one or more hardware logic circuits. The computer program may be stored in a computer-readable non-transitory tangible storage medium as instructions to be executed by a computer. The method for implementing the functions of the units included in the service transceiver 12 does not necessarily include software, and all the functions may be implemented using one or a plurality of pieces of hardware.

(d) Multiple functions of one component in the above embodiment may be implemented by multiple components, or a function of one component may be implemented by multiple components. Multiple functions of multiple elements may be implemented by one element, or one function implemented by multiple elements may be implemented by one element. Part of the configuration of the above embodiment may be omitted. At least a part of the configuration in one embodiment may be added to or substituted for the configuration of another embodiment.

(e) In addition to the above-described communication transceiver, the present disclosure can also be realized in various forms, such as an electronic control device having the communication transceiver as a component thereof, a program for causing a computer to function as the communication transceiver, a non-transitory tangible storage medium such as a semiconductor memory on which the program is stored, and a service-oriented communication method.

### Technical Features Disclosed in Present Disclosure

### Feature 1

A communication transceiver is connected to a main control unit of a communication device configured to be connected to an electronic control device via a single or a plurality of communication lines. The communication transceiver includes: at least one of (i) a circuit and (ii) a processor having a memory storing computer program code.

The at least one of the circuit and the processor having the memory is configured to cause the communication transceiver to:
transmit a presentation message offering to provide a service to the electronic control device according to a first protocol, which is a service-oriented communication protocol, based on first setting information set in response to an instruction from the main control unit; and
in a case where service-oriented communication is established according to the presentation message, (i) convert communication data conforming to a second protocol received from the main control unit into communication data conforming to the first protocol and transmit converted communication data to the electronic control device, or (ii) convert communication data conforming to the first protocol received from the electronic control device into communication data conforming to the second protocol and transmit converted communication data to the main control unit, based on second setting information set in response to an instruction from the main control unit.

### Feature 2

In the communication transceiver according to feature 1, the at least one of the circuit and the processor having the memory is configured to cause the communication transceiver to:
receive a request for subscription to event communication conforming to the first protocol from the electronic control device that has received the presentation message;
register information of a request source requesting the subscription in the service interface unit based on a received request;
receive the communication data conforming to the second protocol from the main control unit;
convert the communication data conforming to the second protocol received from the main control unit into an event message conforming to the first protocol based on the second setting information; and
transmit the event message conforming to the first protocol to the electronic control device based on information of a registered request source.

### Feature 3

In the communication transceiver according to feature 1 or 2, the at least one of the circuit and the processor having the memory is configured to cause the communication transceiver to:
receive a request message conforming to the first protocol from the electronic control device that has received the presentation message;
convert the request message conforming to the first protocol into request message conforming to the second protocol based on the second setting information;
transmit the request message conforming to the second protocol together with an identifier indicating the request message to the main control unit;
receive a response message conforming to the second protocol together with an identifier indicating the response message from the main control unit; and
convert the response message conforming to the second protocol received from the main control unit into response message conforming to the first protocol based on the second setting information, and transmit a converted response message to the electronic control device.

### Feature 4

In the communication transceiver according to any one of features 1 to 3, the at least one of the circuit and the processor having the memory is configured to cause the communication transceiver to:
receive a request for subscription to event communication conforming to the first protocol from the electronic control device that has received the presentation message;
register information of a request source requesting the subscription in the service interface unit based on a received request;
receive the communication data conforming to the second protocol from the main control unit;
convert the communication data conforming to the second protocol received from the main control unit into the communication data conforming to a third protocol different from the first protocol based on the second setting information; and
transmit the communication data conforming to the third protocol to the electronic control device based on information of a registered request source.

### Feature 5

In the communication transceiver according to any one of features 1 to 4, the first protocol is Scalable service-Oriented Middleware over Internet Protocol (i.e., SOME/IP) or Data Distribution Service (i.e., DDS).

### Feature 6

In the communication transceiver according to any one of features 1 to 5, the second protocol conforms to at least one of a Serial Peripheral Interface (i.e., SPI), a Mobile Industry Processor Interface—Camera Serial Interface (i.e., MIPI-CSI), a Mobile Industry Processor Interface—Camera Serial Interface 2 (i.e., MIPI-CSI2), and a Mobile Industry Processor Interface—Display Serial Interface (i.e., MIPI-DSI).

### Feature 7

In the communication transceiver according to features 4, the third protocol is Institute of Electrical and Electronics Engineers (i.e., IEEE) 1722.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A communication transceiver connected to a main control unit of a communication device configured to be connected to an electronic control device via a single or a plurality of communication lines, the communication transceiver comprising:
a service control unit configured to transmit a presentation message offering to provide a service to the electronic control device conforming to a first protocol, which is a service-oriented communication protocol, based on first setting information set in response to an instruction from the main control unit; and
a service interface unit configured to, in a case where service-oriented communication is established according to the presentation message, (i) convert communication data conforming to a second protocol received from the main control unit into communication data conforming to the first protocol and transmit converted communication data to the electronic control device, or (ii) convert communication data conforming to the first protocol received from the electronic control device into communication data conforming to the second protocol and transmit converted communication data to the main control unit, based on second setting information set in response to an instruction from the main control unit.

2. The communication transceiver according to claim 1, wherein:
the service control unit is configured to:
receive a request for subscription to event communication conforming to the first protocol from the electronic control device that has received the presentation message; and
register information of a request source requesting the subscription in the service interface unit based on a received request; and
the service interface unit is configured to:
receive the communication data conforming to the second protocol from the main control unit;
convert the communication data conforming to the second protocol received from the main control unit into an event message conforming to the first protocol based on the second setting information; and
transmit the event message conforming to the first protocol to the electronic control device based on information of a registered request source.

3. The communication transceiver according to claim 1, wherein:
the service interface unit is configured to:
receive a request message conforming to the first protocol from the electronic control device that has received the presentation message;
convert the request message conforming to the first protocol into request message conforming to the second protocol based on the second setting information;
transmit the request message conforming to the second protocol together with an identifier indicating the request message to the main control unit;
receive a response message conforming to the second protocol together with an identifier indicating the response message from the main control unit; and
convert the response message conforming to the second protocol received from the main control unit into response message conforming to the first protocol based on the second setting information, and transmit a converted response message to the electronic control device.

4. The communication transceiver according to claim 1, wherein:
the service control unit is configured to:
receive a request for subscription to event communication conforming to the first protocol from the electronic control device that has received the presentation message; and
register information of a request source requesting the subscription in the service interface unit based on a received request; and
the service interface unit is configured to:
receive the communication data conforming to the second protocol from the main control unit;
convert the communication data conforming to the second protocol received from the main control unit into the communication data conforming to a third protocol different from the first protocol based on the second setting information; and
transmit the communication data conforming to the third protocol to the electronic control device based on information of a registered request source.

5. The communication transceiver according to claim 1, wherein:
the first protocol is Scalable service-Oriented Middleware over Internet Protocol or Data Distribution Service.

6. The communication transceiver according to claim 1, wherein:
the second protocol conforms to at least one of a Serial Peripheral Interface, a Mobile Industry Processor Interface—Camera Serial Interface, a Mobile Industry Processor Interface—Camera Serial Interface 2, and a Mobile Industry Processor Interface—Display Serial Interface.

7. The communication transceiver according to claim 4, wherein:
the third protocol is Institute of Electrical and Electronics Engineers 1722.

8. The communication transceiver according to claim 1, further comprising:
at least one of (i) a circuit and (ii) a processor having a memory storing computer program code, wherein:
the at least one of the circuit and the processor having the memory is configured to cause the communication transceiver to provide at least one of: the service control unit; and the service interface unit.
